(19) United States
(12) Patent Application Publication
(10) Pub. No.: US 2024/0288139 A1
(43) Pub. Date: Aug. 29, 2024

(54) VEHICLE LAMP FITTING

(71) Applicant: Ichikoh Industries, Ltd., Isehara-shi (JP)

(72) Inventor: Shinobu TOMITA, Isehara-shi (JP)

(73) Assignee: Ichikoh Industries, Ltd., Isehara-shi (JP)

(21) Appl. No.: 18/573,711

(22) PCT Filed: Jun. 28, 2022
(86) PCT No.: PCT/JP2022/025745

§ 371 Date: Dec. 22, 2023

(30) Foreign Application Priority Data
Jun. 28, 2021 (JP) 2021-106677

(51) Int. Cl. F21S 41/29; F21S 41/148; F21S 41/26; F21S 41/39; F21S 45/47; F21S 45/49; F21W 102/30

(52) U.S. Cl. CPC F21S 41/29; F21S 41/148; F21S 41/26; F21S 41/39; F21S 45/47; F21S 45/49; F21W 2102/30

(57) ABSTRACT

To provide a vehicle lamp fitting capable of appropriately providing a projection lens while suppressing the number of components and the number of assembly steps. The vehicle lamp fitting includes: a light source; a reflector member having a reflection portion that reflects light emitted by the light source; a projection lens that projects light reflected by the reflection portion to a front; and a heat dissipation member provided with the light source and dissipating heat from the light source; wherein the projection lens is fixed between the heat dissipation member and the reflector member by being sandwiched between the heat dissipation member and the reflector member.

### TECHNICAL FIELD

The present invention relates to a vehicle lamp fitting.

### BACKGROUND ART

There is a vehicle lamp fitting in which light emitted from a light source is reflected by a reflection portion and then projected by a projection lens to form a light distribution pattern (see, for example, Patent Document 1).

In this vehicle lamp fitting, a light source is fixed to an upper surface of a heat sink, a projection lens is sandwiched between an upper housing and a lower housing, a reflection portion is provided in the upper housing, and the lower housing is fixed to the heat sink, whereby a positional relationship among the light source, the reflection portion, and the projection lens is set to a predetermined positional relationship. With this configuration, the vehicle lamp fitting can appropriately project the light from the light source reflected by the reflection portion by the projection lens, and can form an appropriate light distribution pattern.

### CITATION LIST

### Patent Literature

PTL 1: Japanese Patent Laid-open No. 2008-204903

### SUMMARY OF THE INVENTION

### Problems to be Solved by the Invention

However, in the vehicle lamp fitting of the prior art, the upper housing, the lower housing, and the heat sink are used to provide the projection lens in an appropriate positional relationship with respect to the light source and the reflection portion, which leads to an increase in the number of components and the number of assembly steps.

The present disclosure has been made in view of the above-described circumstances, and an object of the present disclosure is to provide a vehicle lamp fitting capable of appropriately providing a projection lens while suppressing the number of components and the number of assembly steps.

### Means for Solving the Problem

A vehicle lamp fitting of the present disclosure includes: a light source; a reflector member having a reflection portion that reflects light emitted by the light source: a projection lens that projects light reflected by the reflection portion to a front; and a heat dissipation member provided with the light source and dissipating heat from the light source: wherein the projection lens is fixed between the heat dissipation member and the reflector member by being sandwiched between the heat dissipation member and the reflector member.

### Effect of the Invention

According to the vehicle lamp fitting of the present disclosure, it is possible to appropriately provide the projection lens while suppressing the number of components and the number of assembly steps.

### BRIEF DESCRIPTION OF THE DRAWINGS

FIG. 1 is an explanatory diagram illustrating a configuration of a vehicle lamp fitting according to a first embodiment of the present disclosure.

FIG. 2 is an explanatory diagram when the vehicle lamp fitting is seen from an upper side in an up-down direction.

FIG. 3 is an explanatory diagram in which the configuration of the vehicle lamp fitting is disassembled and illustrated.

FIG. 4 is an explanatory diagram when a reflector member is seen from an upper side in an up-down direction.

FIG. 5 is an explanatory diagram illustrating a cross-section taken along a line I-I in FIG. 2.

FIG. 6 is an explanatory diagram illustrating a cross-section taken along a line II-II in FIG. 2.

### MODE FOR CARRYING OUT THE INVENTION

Hereinafter, an example embodiment of a vehicle lamp fitting 10 as one example of a vehicle lamp fitting according to the present disclosure will be described with reference to the drawings.

### First Embodiment

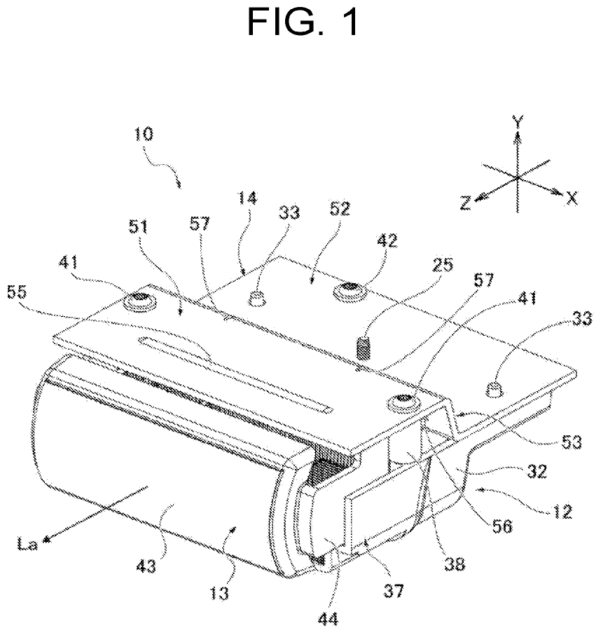

The vehicle lamp fitting 10 of a first embodiment according to one embodiment of the vehicle lamp fitting according to the present disclosure will be described with reference to FIGS. 1 to 6. The vehicle lamp fitting 10 is used as a lamp for a vehicle, such as an automobile, to form a light distribution pattern while traveling and, for example, is used for a headlamp or a fog lamp. The vehicle lamp fitting 10 of the first embodiment is disposed, on each of right and left sides of a front portion of the vehicle, in a lamp chamber in which an opened front end of a lamp housing is covered with an outer lens, via an up-down direction optical axis adjustment mechanism and a width-direction optical axis adjustment mechanism. In the following description, a direction in which an optical axis La of a projection lens 13 extends in the vehicle lamp fitting 10 (light emitting direction) is defined as a front-rear direction (denoted by Z in the drawings), a vertical direction when the front-rear direction is along a horizontal plane is defined as an up-down direction (denoted by Y in the drawings), and a direction orthogonal to the front-rear direction and the up-down direction (horizontal direction) is defined as a width direction (denoted by X in the drawings). A side in the front-rear direction on which the projection lens 13 is provided is defined as a front side, and a side in the up-down direction on which the heat dissipation member 14 is provided is defined as an upper side.

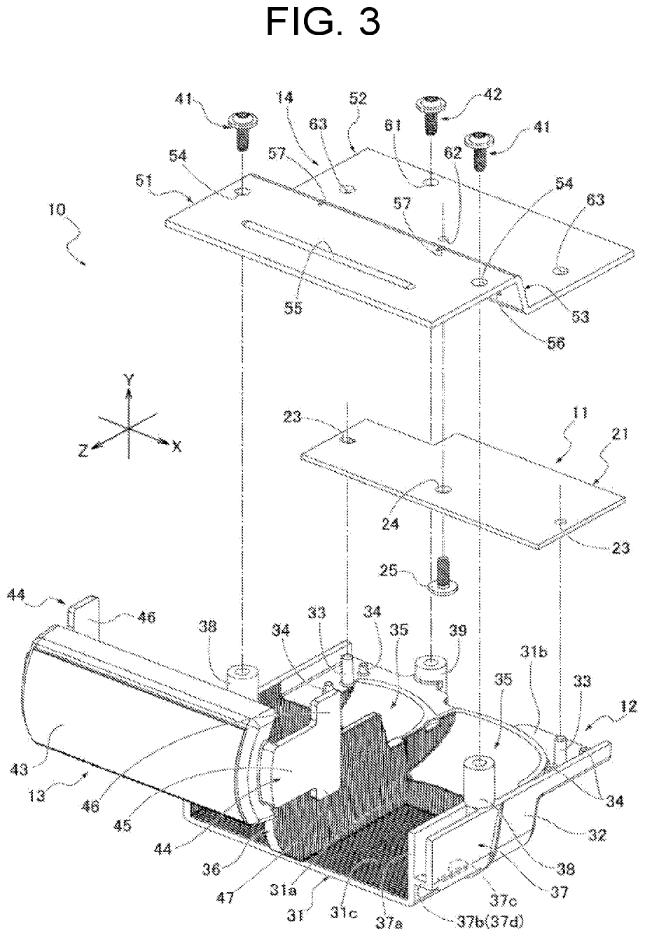

As shown in FIGS. 1 to 3, the vehicle lamp fitting 10 includes a light source portion 11 (see FIG. 3), a reflector member 12, a projection lens 13, and a heat dissipation member 14 that are assembled to each other, and configures a lamp unit that forms a predetermined light distribution pattern. The vehicle lamp fitting 10 is appropriately housed in a housing and provided in a lamp chamber in a state of being assembled as shown in FIG. 1. The vehicle lamp fitting 10 according to the first embodiment forms, as the predetermined light distribution pattern, a traveling light distribution pattern (so-called upper side of high beam) that is used when there is no oncoming vehicle.

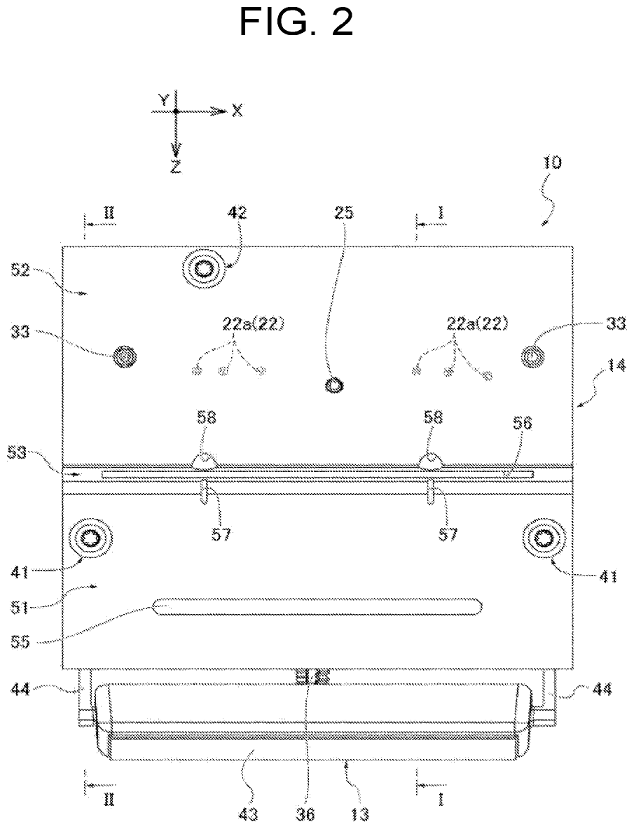

As shown in FIGS. 2, 3, and 5, the light source portion 11 is configured by a substrate 21 and a pair of light emitting portions 22 arranged on the substrate 21. The light emitting portions 22 emit light for forming a light distribution pattern, and are each configured by using a light emitting diode (LED). The light emitting portions 22 are provided on two positions respectively facing two reflection portions 35 in the up-down direction that are provided on the substrate 21 in a pair as described later. Each of the light emitting portions 22 of the first embodiment is configured by three LEDs 22a (see FIG. 2) arranged in the width direction.

The substrate 21 can supply electric power from an electric power supply source mounted in the vehicle to each light emitting portion 22 (each LED 22a thereof), and is an aluminum substrate or a glass epoxy substrate in the first embodiment. The substrate 21 is formed to have a plate shape elongated in the width direction, and a portion on one side in the width direction and on the rear side in the front-rear direction is partially cut out. The substrate 21 appropriately supplies electric power to each of the light emitting portions 22 to appropriately turn on each of the light emitting portions 22.

As shown in FIG. 3, the substrate 21 is provided with two positioning holes 23 and one fixing hole 24. The two positioning holes 23 and the fixing hole 24 penetrate the substrate 21. The two positioning holes 23 determine the position of the substrate 21 with respect to the reflector member 12 in a direction along a plane including the front-rear direction and the width direction. The two positioning holes 23 are respectively provided in the vicinity of both end portions of the substrate 21 in the width direction, and in the first embodiment, one of the two positioning holes 23 (on the lower right side when viewed from the front in FIG. 3) has a circular cross section, and the other of the two positioning holes 23 (on the upper left side when viewed from the front in FIG. 3) has a cross section of a long hole elongated in the width direction. The two positioning holes 23 have a positional relationship corresponding to positioning protrusions 33 provided on the reflector member 12, and the corresponding positioning protrusion 33 can be inserted through each of the positioning holes 23.

The fixing hole 24 is for fixing the substrate 21 to the heat dissipation member 14. The fixing hole 24 is provided substantially at the center of the substrate 21 in the width direction and has a circular cross section. The fixing hole 24 can receive a fixing screw 25. The fixing screw 25 is capable of fixing by being screwed into the fixing hole 62 of the heat dissipation member 14.

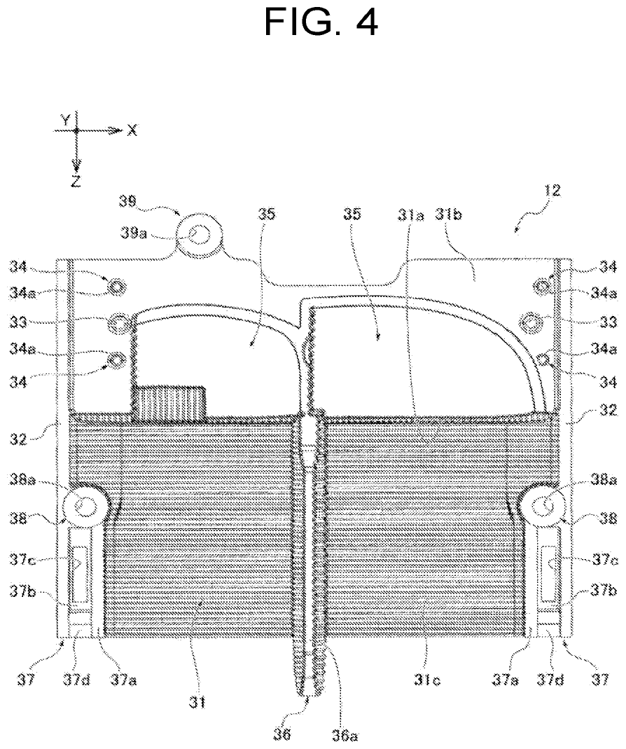

As shown in FIGS. 3 and 4, the reflector member 12 includes a bottom plate portion 31 extending in the front-rear direction and side wall portions 32 provided at both edges of the bottom plate portion 31 in the width direction. In the first embodiment, the reflector member 12 is formed of a heat-resistant resin material. The bottom plate portion 31 is provided with a step portion 31a in the middle in the front-rear direction, and a rear step portion 31b on the rear side of the step portion 31a is positioned above a front step portion 31c on the front side of the step portion 31a in the up-down direction. The side wall portion 32 has a plate shape extending upward and in the front-rear direction from each of both sides of the bottom plate portion 31, and increases the strength of the reflector member 12 (the bottom plate portion 31). The reflector member 12 is provided with two positioning protrusions 33, a plurality of reference surface protrusions 34, a pair of reflection portions 35, a partition plate 36, a pair of lens support portions 37, a pair of front side screw receiving portions 38, and a rear side screw receiving portion 39.

The positioning protrusions 33 and the reference surface protrusions 34 determine the positional relationship between the light source portion 11 and the reflector member 12 (the reflection portions 35 thereof), and are provided to protrude upward in the up-down direction from the rear step portion 31b. The two positioning protrusions 33 determine the position of the light source portion 11 with respect to the reflector member 12 in a direction along a plane including the front-rear direction and the width direction. The two positioning protrusions 33 have a positional relationship corresponding to the two positioning holes 23 on the substrate 21, and each of the positioning protrusions 23 is provided in the vicinity of both ends of the rear step portion 31b in the width direction. The two positioning protrusions 33 of the first embodiment have the same cylindrical shape, and can each be inserted into the corresponding positioning hole 23.

The plurality of reference surface protrusions 34 determine the position of the light source portion 11 with respect to the reflector member 12 in the up-down direction, and are provided to protrude upward in the up-down direction from the rear step portion 31b. The reference surface protrusions 34 have the same cylindrical shape, and their tip end surfaces 34a (see FIG. 4) are on a single plane that is perpendicular to the up-down direction. When the substrate 21 is placed on the tip end surfaces 34a of the reference surface protrusions 34, the substrate 21 is set in a posture orthogonal to the up-down direction and the position of the substrate 21 with respect to the rear step portion 31b (reflector member 12) in the up-down direction is determined. In the first embodiment, two reference surface protrusions 34 are provided in a vicinity of each of both ends in the width direction of the rear step portion 31b, and therefore, a total of four reference surface protrusions 34 are provided. Note that the number, location, and shape of the reference surface protrusions 34 may be appropriately set as long as the reference surface protrusion 34 determines the posture and position of the substrate 21 as described above, and are not limited to the configuration of the first embodiment.

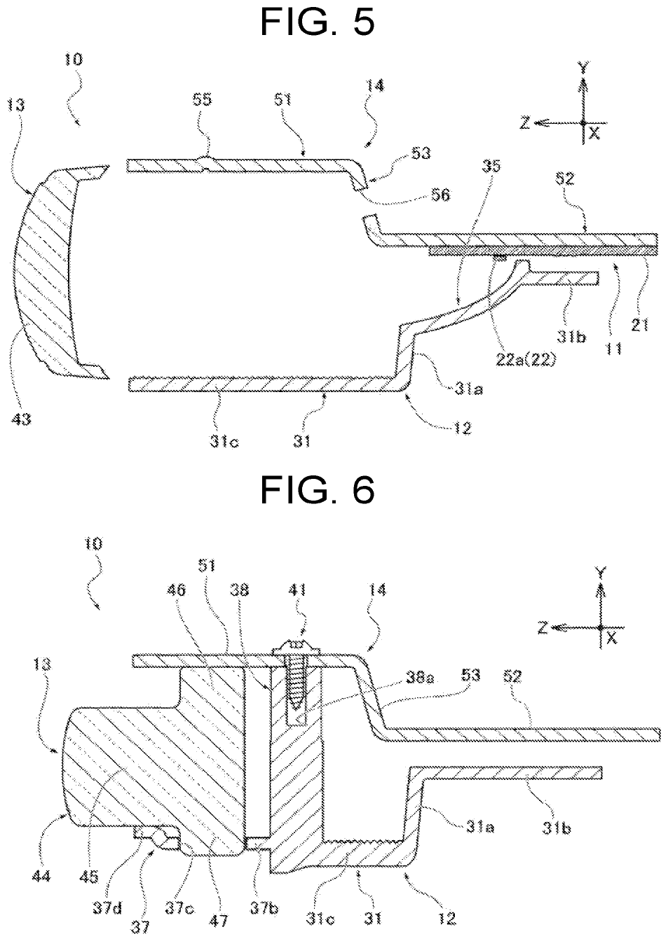

The reflection portions 35 are provided in a pair in the width direction, and each of the reflection portions 35 correspondingly and individually face each of the light emitting portions 22 of the light source portions 11 in the up-down direction, and reflect the light emitted from the corresponding light emitting portion 22 to the projection lens 13 side. Each of the reflection portions 35 is formed by partially recessing a corner portion between the step portion 31a and the rear step portion 31b of the bottom plate portion 31 and performing aluminum vapor deposition on the surfaces of the corner portion. Each of the reflection portions 35 has a free-form surface based on an ellipse that has a first focal point on the corresponding light emitting portion 22 (the center position thereof) and a second focal point on an arbitrary position on the front side of the reflection portion 35 in the front-rear direction. As shown in FIG. 5, a rear end portion of each of the reflection portions 35 of the first embodiment protrudes upward from the rear step portion 31b so that light from the light source portion 11 (each of the light emitting portions 22) can be efficiently used. The rear end portion of each of the reflection portions 35 has such a height that the rear end portion does not come into contact with the substrate 21 of the light source portion 11 in a state in which the vehicle lamp fitting 10 is assembled, and does not hinder positioning of the substrate 21.

As shown in FIGS. 3 and 4, the partition plate 36 is provided on the front step portion 31c of the bottom plate portion 31. The partition plate 36 has a plate shape orthogonal to the width direction and is provided to protrude upward in the up-down direction from the front step portion 31c at the center in the width direction, and the rear end portion of the partition plate 36 is connected to the step portion 31a. The partition plate 36 divides a space above the front step portion 31c, that is, a space in front of the two reflection portions 35 of the reflector member 12 into two spaces in the width direction. The partition plate 36 prevents light reflected by each of the paired reflection portions 35 from being mixed (so-called crosstalk). Further, an upper edge portion 36a (see FIG. 4) on the upper side of the partition plate 36 in the up-down direction is inclined substantially equally to the front side piece portion 51 from the inclined piece portion 53 when the heat dissipation member 14 is viewed in a cross-section orthogonal to the width direction. Further, the upper edge portion 36a of the partition plate 36 is located at a height position slightly lower in the up-down direction than the front side screw receiving portions 38 of the front step portion 31c of the reflector member 12.

A pair of lens support portions 37 are provided on both edges in the width direction of the front step portion 31c of the bottom plate portion 31 at positions where the projection lens 13 is supported. Each lens support portion 37 has a support wall portion 37a extending parallel to each side wall portion 32 inside this side wall portion 32, a support piece 37b connecting the support wall portion 37a and the side wall portion 32 in the width direction, and a positioning hole 37c provided in the support piece 37b. Each support wall portion 37a has a plate shape protruding upward in the up-down direction from the front step portion 31c, and a gap between the support wall portion 37a and the side wall portion 32 is set to a size capable of receiving a mounting piece portion 44 of the projection lens 13.

A front end portion of the support piece 37b in the front-rear direction is a support point 37d. The support point 37d is configured by partially displacing the front end portion of the support piece 37b upward in the up-down direction (see FIG. 6 and the like). The positioning hole 37c penetrates through a part of the support piece 37b on the rear side of the support point 37d in the up-down direction, and has a size that allows the positioning protrusion 47 of the mounting piece portion 44 to be fitted therein. Therefore, each lens support portion 37 is configured so that the corresponding mounting piece portion 44 can be inserted between the support wall portion 37a and the side wall portion 32 and the position with respect to the projection lens 13 can be determined in the front-rear direction and the width direction by fitting the positioning protrusion 47 into the positioning hole 37c. Further, in a state in which the positioning protrusion 47 is fitted into the positioning hole 37c, each lens support portion 37 can support a mounting base portion 45 of the mounting piece portion 44 at the support point 37d (see FIG. 6). In other words, since each lens support portion 37 supports the mounting base portion 45 of the mounting piece portion 44 at the support point 37d, even if the corner portion between the mounting base portion 45 and the positioning protrusion 47 of each mounting piece portion 44 is curved, the positioning protrusion 47 can be appropriately fitted into the positioning hole 37c.

A pair of front side screw receiving portions 38 constitute portions for mounting the heat dissipation member 14 to the reflector member 12, and are provided at both edges in the width direction of the front step portion 31c of the bottom plate portion 31 to be adjacent to the rear side in the front-rear direction of each lens support portion 37. Each front side screw receiving portion 38 is formed to have a cylindrical shape extending upward in the up-down direction from the front step portion 31c and along the side wall portion 32, and a screw hole 38a (see FIGS. 4 and 6) is provided at the center thereof. The screw hole 38a can receive a mounting screw 41 from the upper side in the up-down direction. The mounting screw 41 can be inserted through a corresponding mounting hole 54 of the heat dissipation member 14, and fixes a front portion (mainly, a front side piece portion 51 described later) of the heat dissipation member 14 to the reflector member 12 by being screwed into the screw hole 38a in a state of being inserted through the mounting hole 54 (see FIG. 6).

A rear side screw receiving portion 39 constitutes portions for mounting the heat dissipation member 14 to the reflector member 12 along with the two front side screw receiving portion 38, and are provided at an edge portion on the rear side in the front-rear direction of the rear step portion 31b of the bottom plate portion 31. The rear side screw receiving portion 39 is formed to have a cylindrical shape extending in the up-down direction, and a screw hole 39a (see FIG. 4) is provided at the center thereof. The screw hole 39a can receive a mounting screw 42 from the upper side in the up-down direction. The mounting screw 42 can be inserted through a corresponding mounting hole 61 of the heat dissipation member 14, and fixes a rear portion (mainly, a rear side piece portion 52 described later) of the heat dissipation member 14 to the reflector member 12 by being screwed into the screw hole 39a in a state of being inserted through the mounting hole 61.

A space (optical path) through which light reflected by each of the reflection portions 35 travels to the projection lens 13 is formed by a portion of the reflector member 12 from each of the reflection portions 35 to the front end of the front step portion 31c. In the reflector member 12 according to the first embodiment, a diffusion surface is formed by portions facing this space (optical path), that is, surfaces of the step portion 31a and the front step portion 31c of the bottom plate portion 31, both side surfaces of the partition plate 36, and surfaces of the side wall portions 32 adjacent to the front step portion 31c. In the first embodiment, the diffusion surface has a so-called knurled surface in which convex portions extending in the up-down direction are formed in parallel in the front-rear direction or the width direction, and convex portions extending in the width direction are formed in parallel in the front-rear direction. As a result, the reflector member 12 can prevent light from each light source portion 11 from being projected from the projection lens 13 in an unintended direction or mode.

The projection lens 13 projects light emitted from the two light emitting portions 22 to the front side in the front-rear direction and, as shown in FIG. 3, includes a lens main body portion 43 and a pair of mounting piece portions 44. The lens main body portion 43 functions as a lens that projects light from the two light emitting portions 22 in the projection lens 13 and, in the first embodiment, is a convex lens having a substantially quadrangular shape when viewed from the front side in the front-rear direction. Note that the quadrangular shape may be a rectangular shape or may have curved sides as long as there are four corner portions (including those chamfered into a sphere surface, or the like). In addition, the shape of the lens main body portion 43 viewed in the front-rear direction may be appropriately set, and is not limited to the configuration of the first embodiment. The lens main body portion 43 is configured such that the incident surface corresponds to the pair of light emitting portions 22, and is divided into a right side and a left side in the width direction with the optical axis La as a center, and each of the right side and the left side has an optical setting. Each of the pair of incident surfaces faces the corresponding light emitting portion 22 in the front-rear direction, and forms a desired light distribution pattern by projecting light from the light emitting portion 22 to the front side.

The lens main body portion 43 (projection lens 13) of the first embodiment is set to have a function as an adaptive driving beam (ADB), and light from one of the light emitting portions 22 and light from the other of the light emitting portions 22 form respective traveling light distribution patterns and form respective traveling light distribution patterns at different positions in the width direction. A position where the traveling light distribution pattern is formed is mainly set by an incident surface of the lens main body portion 43. Note that the light distribution pattern formed by the lens main body portion 43 (projection lens 13) may be appropriately set, and are not limited to the configuration of the first embodiment.

The two mounting piece portions 44 are portions to mount the lens main body portion 43 (projection lens 13) to the reflector member 12. Each of the mounting piece portions 44 protrudes rearward in the front-rear direction from both ends in the width direction of the lens main body portion 43, and has a plate shape orthogonal to the width direction. Each of the mounting piece portions 44 includes a mounting base portion 45 extending rearward in the front-rear direction from the lens main body portion 43, a mounting protrusion 46 protruding upward in the up-down direction from a rear portion of the mounting base portion 45, and a positioning protrusion 47 protruding downward from a rear portion of the mounting base portion 45. Therefore, each of the mounting piece portions 44 has a substantially T-shape protruding rearward from the lens main body portion 43. Further, in each of the mounting piece portions 44, a corner portion between the mounting base portion 45 and the mounting protrusion 46 and a corner portion between the mounting base portion 45 and the positioning protrusion 47 are curved (rounded) to prevent stress concentration. Each of the mounting piece portions 44 has a thickness (dimension in the width direction) that allows the mounting piece portion 44 to be inserted between the support wall portion 37a of the corresponding lens support portion 37 and the side wall portion 32 with a predetermined gap between the mounting piece portions 44 and each of the support wall portion 37a and the side wall portion 32.

Each of the positioning protrusions 47 has a thickness that allows the positioning protrusion 47 to be fitted into the positioning hole 37c of the corresponding lens support portion 37, that is, there is almost no space between the positioning protrusion 47 and the positioning hole 37c in a state in which the positioning protrusion 47 is inserted through the positioning hole 37c. When the positioning protrusions 47 are fitted into the corresponding positioning holes 37c, the mounting base portions 45 of the mounting piece portions 44 are supported by the support points 37d of the corresponding lens support portions 37 (see FIG. 6). In a state in which the mounting piece portions 44 are positioned and supported by the lens support portions 37, the mounting protrusions 46 are positioned at the same height as or slightly higher than the front side screw receiving portions 38 of the front step portion 31c of the reflector member 12 in the up-down direction.

The heat dissipation member 14 is a heat sink member that dissipates heat generated in each light emitting portion 22 (each light emitting element) provided in the light source portion 11 to the outside. The heat dissipation member 14 is formed of a metal material having high thermal conductivity and, in the first embodiment, the heat dissipation member 14 is formed of an aluminum die-casting material of metal die-casting material in which an alumite treatment is performed on an outer surface thereof. As shown in FIGS. 1 to 3, the heat dissipation member 14 has a plate shape extending in the front-rear direction, and includes a front side piece portion 51 extending along a plane orthogonal to the up-down direction, a rear side piece portion 52 positioned below and behind the front side piece portion 51 and parallel to the front side piece portion 51, and an inclined piece portion 53 connecting the front side piece portion 51 and the rear side piece portion 52. The inclined piece portion 53 is inclined downward toward the rear side. Note that the heat dissipation member 14 may be provided with a plurality of heat dissipation fins protruding upward and arranged in parallel, and may be provided with a cooling fan unit to increase cooling efficiency.

The front side piece portion 51 is provided with a pair of mounting holes 54 and a reinforcing convex portion 55. Each of the mounting holes 54 is provided for fixing the heat dissipation member 14 to the reflector member 12 and is formed to penetrate the front side piece portion 51 in the up-down direction, and the corresponding mounting screw 41 can be inserted through the mounting hole 54. The mounting holes 54 have a positional relationship corresponding to the pair of front side screw receiving portions 38 of the reflector member 12, and are positioned on the rear side of the front side piece portion 51 in the front-rear direction. That is, more than half of the front side piece portion 51 in the front-rear direction is positioned in the front side of the mounting holes 54.

The reinforcing convex portion 55 is formed by partially protruding the front side piece portion 51 upward on the inner side and the front side of the mounting holes 54 of the front side piece portion 51 (see FIG. 5), and extends linearly in the width direction. The reinforcing convex portion 55 prevents the center of the front side piece portion 51 in the width direction, particularly the front side of the mounting holes 54, from being bent in the up-down direction. Such a reinforcing convex portion 55 can be formed by, for example, partially extruding the front side piece portion 51 from the lower side. Since the reinforcing convex portion 55 is formed to protrude upward, the reinforcing convex portion 55 does not hinder the progress of light from each of the reflection portions 35 to the projection lens 13 under the front side piece portion 51 (the heat dissipation member 14) as described later. Note that the number, shape, number, and the like of the reinforcing convex portions 55 may be appropriately set in accordance with a mode in which bending occurs, and the reinforcing convex portion 55 may not be provided in a case where there is no concern of above-described bending, and is not limited to the configuration of the first embodiment.

The inclined piece portion 53 is provided with an opening portion 56. The opening portion 56 is formed to penetrate through the inclined piece portion 53 (see FIG. 5), and is elongated in the width direction. Therefore, the inclined piece portion 53 is connected only at the outer side in the width direction of the opening portion 56 (see FIG. 2). Since the opening portion 56 is provided to the inclined piece portion 53, the opening portion 56 does not hinder the progress of light from each of the reflection portion 35 to the projection lens 13. Note that the position (including the front side piece portion 51 and the rear side piece portion 52), the size, and the number of the opening portion 56 may be appropriately set as long as the opening portion 56 does not hinder the progress of light from each of the reflection portions 35 to the projection lens 13, and the opening portion 56 is not limited to the configuration of the first embodiment.

Further, the inclined piece portion 53 is provided with two upper side reinforcing concave portions 57 between the inclined piece portion 53 and the front side piece portion 51 and two lower side reinforcing concave portions 58 between the inclined piece portion 53 and the rear side piece portion 52. Each of the two upper side reinforcing concave portions 57 is formed by partially recessing a corner extending from the inclined piece portion 53 to the front side piece portion 51, and have a thin linear shape in the first embodiment. The two upper side reinforcing concave portions 57 reinforce the vicinity of the corner extending from the inclined piece portion 53 to the front side piece portion 51. Further, each of the two lower side reinforcing concave portions 58 is formed by partially recessing a corner extending from the inclined piece portion 53 to the rear side piece portion 52, and has a wider shape than the upper side reinforcing concave portion 57 (wider size in the width direction) in the first embodiment. The two lower side reinforcing concave portions 58 reinforce the vicinity of the corner extending from the inclined piece portion 53 to the rear side piece portion 52. Note that the number, shape, number, and the like of the upper side reinforcing concave portions 57 and the lower side reinforcing concave portions 58 may be set as appropriate, and the upper side reinforcing concave portions 57 and the lower side reinforcing concave portions 58 may not be provided in a case where the strength of each corner portion is sufficiently ensured, and are not limited to the configuration of the first embodiment.

The rear side piece portion 52 is provided with a mounting hole 61, a fixing hole 62, and a pair of release holes 63. The mounting holes 61 is provided for fixing the heat dissipation member 14 to the reflector member 12 and is formed to penetrate the rear side piece portion 52 in the up-down direction, and the corresponding mounting screw 42 can be inserted through the mounting hole 54. The mounting hole 61 has a positional relationship corresponding to the rear side screw receiving portion 39 of the reflector member 12, and is located at the position in the rear side piece portion 52 that is on the rear side in the front-rear direction and deviated in the width direction. Thus, the position of the mounting hole 61 corresponds to the cut-out portion of the substrate 21 of the light source portion 11, and the mounting hole 61 faces the rear side screw receiving portion 39 in the up-down direction without the substrate 21 interposed therebetween.

The fixing hole 62 is for mounting the substrate 21 to the heat dissipation member 14. The fixing hole 62 is formed to penetrate the rear side piece portion 52 in the up-down direction, and a corresponding fixing screw 25 can be screwed into the fixing hole 62. The fixing hole 62 has a positional relationship corresponding to the fixing hole 24 of the substrate 21 and is at the position in the rear side piece portion 52 that is the front side in the front-rear direction and substantially at the center in the width direction.

The pair of release holes 63 are provided for positioning the substrate 21 with respect to the reflector member 12. Each of the release holes 63 is provided to penetrate the rear side piece portion 52, and has a positional relationship corresponding to each of the positioning holes 23 of the substrate 21. Each release hole 63 can receive each positioning protrusion 33 protruding from each positioning hole 23 (substrate 21) in a state in which each positioning protrusion 33 of the reflector member 12 is inserted into each positioning hole 23 of the substrate 21. Each release hole 63 has a larger diameter than each positioning hole 23, and does not have a function of positioning with respect to each positioning protrusion 33.

Next, a method of assembling the vehicle lamp fitting 10 will be described mainly with reference to FIG. 3. Firstly, a fixing step of fixing the light source portion 11 to the heat dissipation member 14 is performed. In the fixing step, the rear surface of the substrate 21 is attached to the lower surface of the rear side piece portion 52 of the heat dissipation member 14 in a state in which the two positioning holes 23 and the fixing hole 24 of the substrate 21 provided with the pair of light emitting portions 22 overlap the two release holes 63 and the fixing hole 62 of the rear side piece portion 52 of the heat dissipation member 14. Then, in the fixing step, the light source portion 11 is fixed to the heat dissipation member 14 by screwing a fixing screw 25 into the fixing hole 62 of the rear side piece portion 52 while the fixing screw 25 being inserted through the fixing hole 24 of the substrate 21 from the lower side.

Next, an installing step of installing the projection lens 13 on the reflector member 12 is performed. In the installing step, each mounting piece portion 44 of the projection lens 13 is arranged between the support wall portion 37a of each lens support portion 37 and the side wall portion 32 of the reflector member 12 from an upper side, and the positioning protrusion 47 of each mounting piece portion 44 is inserted into the positioning hole 37c of the support piece 37b of each lens support portion 37. At this time, since each mounting piece portion 44 has a thickness that allows the mounting piece portion 44 to have a predetermined gap between the mounting piece portion 44 and each of the support wall portions 37a and the side wall portions 32, the mounting piece portions 44 can be easily disposed between the support wall portions 37a and the side wall portions 32. Then, the mounting base portion 45 of each mounting piece portion 44 is placed on the support point 37d of each lens support portion 37. Therefore, the position of the projection lens 13 in the front-rear direction and the width direction is determined by the insertion of the positioning protrusions 47 into the positioning holes 37c, and the position of the projection lens 13 in the up-down direction is determined by the mounting base portion 45 being supported by the support point 37d. Note that, when it is not easy to insert the positioning protrusions 47 into the positioning holes 37c, at least one of the mounting piece portions 44 and the lens support portions 37 may be provided with a guide mechanism for guiding the insertion. This guide mechanism can be configured, for example, by providing an inclination at the tip end of each positioning protrusion 47 or by providing an inclined surface between the support wall portion 37a and the side wall portion 32.

Finally, a mounting step of mounting the heat dissipation member 14 to the reflector member 12 is performed. In the mounting step, the heat dissipation member 14 is placed on the reflector member 12 while inserting each positioning protrusion 33 of the rear step portion 31b of the reflector member 12 into each positioning hole 23 of the substrate 21 of the light source portion 11 fixed to the heat dissipation member 14. Then, the substrate 21 is supported by the tip end surfaces 34a of the four reference surface protrusions 34. Thus, the substrate 21 is positioned in the front-rear direction and the width direction by the insertion of the positioning protrusions 33 into the positioning holes 23, and is positioned in the up-down direction by the support of the distal end surfaces 34a of the reference surface protrusions 34. Therefore, each light emitting portion 22 of the substrate 21 is located at an appropriate position with respect to each reflection portion 35 of the reflector member 12.

Thereafter, in the mounting step, each mounting screw 41 is inserted through each mounting hole 54 of the front side piece portion 51 of the heat dissipation member 14 from the upper side and screwed into each front side screw receiving portion 38 of the front step portion 31c of the reflector member 12, whereby the front side piece portion 51 is mounted to the front step portion 31c of the reflector member 12. Here, in a state in which the mounting piece portions 44 are positioned and supported by the lens support portions 37, the mounting protrusions 46 are positioned at the same height as or slightly higher than the front side screw receiving portions 38 of the front step portion 31c of the reflector member 12 in the up-down direction. Therefore, since the both edge portions in the width direction of the front side piece portion 51 (heat dissipation member 14) are pressed downwardly and fixed at the positions of the front side screw receiving portions 38, the portion of the front side piece portion 51 that is the front side of the front side screw receiving portions 38 is pressed against the mounting protrusions 46 of the mounting piece portions 44 of the projection lens 13 supported by the lens support portions 37. Accordingly, the front side piece portion 51 (heat dissipation member 14) can apply force downwardly in the up-down direction to the mounting piece portions 44 by using elastic force (bending force) of the front side piece portion 51, and the mounting base portion 45 of each mounting piece portion 44 can be pressed against the support point 37d of each lens support portion 37. Therefore, the projection lens 13 is supported by the mounting piece portions 44 of the projection lens 13 being sandwiched between the reflector member 12 and the heat dissipation member 14 in the up-down direction.

In this case, since the upper edge portion 36a of the partition plate 36 is inclined substantially equally to the front side piece portion 51 from the inclined piece portion 53 and is located at a height position slightly lower than the front side screw receiving portions 38 of the reflector member 12, the upper edge portion 36a is arranged along the heat dissipation member 14 without contacting the heat dissipation member 14. Therefore, the partition plate 36 does not hinder the heat dissipation member 14 from pressing the mounting piece portions 44 against the reflector member 12, and can prevent light reflected by the respective reflection portions 35 from being mixed.

In addition, in the mounting step, the mounting screw 42 is inserted through the mounting hole 61 of the rear side piece portion 52 of the heat dissipation member 14 from the upper side and screwed into the rear side screw receiving portion 39 of the front step portion 31c of the reflector member 12. Accordingly, the rear side piece portion 52 of the heat dissipation member 14 is fixed to the front step portion 31c, and the substrate 21 (light source portion 11) fixed to the rear side piece portion 52 is positioned with respect to the reflection portions 35 by the positioning protrusions 33 and the reference surface protrusions 34. Therefore, the heat dissipation member 14 is mounted to the reflector member 12 with the projection lens 13 being sandwiched and fixed between the heat dissipation member 14 and the reflector member 12, and the light source portion 11 having the appropriate positional relationship with respect to the reflector member 12.

Thus, the vehicle lamp fitting 10 is assembled. In the vehicle lamp fitting 10, the reflector member 12 and the heat dissipation member 14 have both a function as a lens holder for fixing the projection lens 13 and a function as a housing for surrounding a space (optical path) in which light from the light source portions 11 is reflected by the reflection portions 35 and travels to the projection lens 13. The vehicle lamp fitting 10 supplies electric power from an electric power supply source to the light emitting portions 22 of the light source portion 11 to appropriately turn on and off the light emitting portions 22, and projects light from each of the light emitting portions 22 in accordance with optical setting of the projection lens 13 to form a low-beam light distribution pattern. When the vehicle lamp fitting 10 is turned on, the position of the traveling light distribution pattern to be formed is changed by changing the light source portion 11 to be turned on in accordance with the steering of the steering wheel of the vehicle on which the vehicle lamp fitting 10 is mounted.

Next, an effect of the vehicle lamp fitting 10 will be described. In the vehicle lamp fitting 10, since the projection lens 13 is sandwiched and fixed between the reflector member 12 provided with the reflection portions 35 for reflecting light from the light source portion 11 and the heat dissipation member 14 for dissipating heat from the light source portion 11, the projection lens 13 can be provided while suppressing the number of components and the number of assembly steps. Further, since the vehicle lamp fitting 10 uses the heat dissipation member 14 to which the light source portion 11 is fixed in the fixing step, all the other steps of mounting the projection lens 13 and the heat dissipation member 14 to the reflector member 12 that is positioned under the projection lens 13 and the heat dissipation member 14 can be performed from the upper side. For these reasons, the assembly work and the work line of this assembly of the vehicle lamp fitting 10 can be simplified, and the manufacturing cost can be effectively suppressed.

In addition, in the vehicle lamp fitting 10, since the opening portion 56 is provided in the inclined piece portion 53 of the heat dissipation member 14, it is possible to suppress heat from the light source portion 11 from being transmitted to the projection lens 13. This is because of the following reasons. In the vehicle lamp fitting 10, since the opening portion 56 is provided in the rear side piece portion 52, a path through which heat is transmitted from the rear side piece portion 52 to the front side piece portion 51 can be made small and thereby the influence of heat on the projection lens 13 can be suppressed. Further, in the vehicle lamp fitting 10, although it is contemplated that air in the space (optical path) surrounded by the heat dissipation member 14 and the reflector member 12 is heated by heat from the light source portion 11, the heated air can be released through the opening portion 56 and thereby an influence of heat on the projection lens 13 can be suppressed. In addition, in the vehicle lamp fitting 10, parts of the both edge portions of the front side piece portion 51 of the heat dissipation member 14 presses the mounting piece portions 44 (mounting protrusions 46 thereof) of the projection lens 13 downwardly. Therefore, in the vehicle lamp fitting 10, a contact area between the heat dissipation member 14 and the projection lens 13 can be made small, and a path through which heat is transmitted from the heat dissipation member 14 to the lens main body portion 43 of the projection lens 13 can be lengthened. According to the above, in the vehicle lamp fitting 10, it is possible to suppress heat from the light source portion 11 from being transmitted to the projection lens 13 and prevent influence by heat to the optical characteristic of the projection lens 13 (lens main body portion 43 thereof).

Further, in the vehicle lamp fitting 10, the positional relationship between the light emitting portions 22 of the substrate 21 and the reflection portions 35 of the reflector member 12 is set by the insertion of each positioning protrusion 33 into each positioning hole 23 and the support of the substrate 21 by the tip end surfaces 34a of the reference surface protrusions 34. Therefore, in the vehicle lamp fitting 10, since the heat dissipation member 14 to which the light source portion 11 is fixed is not used for positioning, it is possible to position the light emitting portions 22 more appropriately and the reflection portions 35 compared to a case where the heat dissipation member 14 is used for positioning.

The vehicle lamp fitting 10 of the first embodiment can achieve each of the following effects.

In the vehicle lamp fitting 10, the projection lens 13 is sandwiched between the heat dissipation member 14 and the reflector member 12, and thereby, is fixed between the heat dissipation member 14 and the reflector member 12. Therefore, in the vehicle lamp fitting 10, the heat dissipation member 14 and the reflector member 12 also function as a lens holder for fixing the projection lens 13, and the number of components and the number of assembly steps for providing the projection lens 13 can be suppressed while maintaining an appropriate positional relationship between the light source portion 11 provided on the heat dissipation member 14 and the reflection portion 35 provided on the reflector member 12.

In the vehicle lamp fitting 10, the heat dissipation member 14 and the reflector member 12 surround a space in which light travels from the reflection portion 35 to the projection lens 13. Therefore, in the vehicle lamp fitting 10, the heat dissipation member 14 and the reflector member 12 also function as a housing for surrounding the space (optical path) in which light travels, and the projection lens 13 can be provided while further suppressing the number of components and the number of assembly steps.

In the vehicle lamp fitting 10, the heat dissipation member 14 is formed to have a plate shape extending from the light source (light source portion 11) to the projection lens 13, and the projection lens 13 is pressed against the reflector member 12 by the elastic force of the heat dissipation member 14. Therefore, in the vehicle lamp fitting 10, the projection lens 13 can be more appropriately fixed to the reflector member 12, and the position of the projection lens 13 with respect to the reflection portion 35 can be made more appropriate.

In the vehicle lamp fitting 10, the opening portion 56 is provided in the heat dissipation member 14 between the light source (light source portion 11) and the projection lens 13. Therefore, in the vehicle lamp fitting 10, a path through which heat is transmitted can be made small by the opening portion 56 and the heated air can be released through the opening portion 56, and it is possible to suppress heat from the light source portion 11 from being transmitted to the projection lens 13.

In the vehicle lamp fitting 10, the projection lens 13 has the lens main body portion 43 for projecting light and the mounting piece portion 44 protruding from the lens main body portion 43, and the heat dissipation member 14 and the reflector member 12 sandwich the mounting piece portion 44 to fix the projection lens 13. Therefore, the vehicle lamp fitting 10 can prevent the sandwiching force by the heat dissipation member 14 and the reflector member 12 from acting on the lens main body portion 43, and can lengthen the path through which heat is transferred from the heat dissipation member 14 to the lens main body portion 43. As a result, in the vehicle lamp fitting 10, it is possible to prevent influence to the optical characteristic caused by the sandwiching force and the heat applied to the lens main body portion 43 of the projection lens 13, and to appropriately form the light distribution pattern.

In the vehicle lamp fitting 10, the reflector member 12 includes the lens support portion 37 that supports the mounting piece portion 44 and the screw receiving portion (the front side screw receiving portion 38 in the first embodiment) to which the heat dissipation member 14 is mounted via the mounting screw 41, and the lens support portion 37 and the front side screw receiving portion 38 are adjacent to each other. Therefore, in the vehicle lamp fitting 10, the projection lens 13 can be pressed against the reflector member 12 by efficiently using the force with which the heat dissipation member 14 is fixed to the front side screw receiving portion 38 by the mounting screw 41, and the projection lens 13 can be more appropriately fixed to the reflector member 12.

In the vehicle lamp fitting 10, the mounting piece portion 44 is provided with the positioning protrusion 47 protruding toward the lens support portion 37, and the lens support portion 37 is provided with the positioning hole 37c into which the positioning protrusion 47 can be fitted. Therefore, in the vehicle lamp fitting 10, the lens support portion 37 and the mounting piece portion 44 can be set to have an appropriate positional relationship by fitting the positioning protrusion 47 into the positioning hole 37c in a state in which the lens support portion 37 supports the mounting piece portion 44.

Therefore, in the vehicle lamp fitting 10 of the first embodiment as the vehicle lamp fitting according to the present disclosure, the projection lens 13 can be appropriately provided while suppressing the number of components and the number of assembly steps.

Hereinbefore, while the vehicle lamp fitting of the present disclosure has been described on the basis of the first embodiment, the specific configuration is not limited to the first embodiment, and changes and additions, etc. of design are permitted without departing from the gist of the invention claimed in each claim in the claims.

In the first embodiment, the vehicle lamp fitting 10 reflects light from the pair of light source portions 11 by the corresponding reflection portions 35 to form the traveling light distribution patterns at different positions in the width direction, thereby constituting the ADB. However, in the vehicle lamp fitting 10, the positions, shapes, and numbers of the light source portions 11 and the reflection portions 35, the types and timings of the light distribution patterns formed by the light source portions 11 and the reflection portions 35, and the like may be appropriately set and are not limited to the configuration of the first embodiment. Note that, when the vehicle lamp fitting 10 forms a low-beam light distribution pattern, it is necessary to form a cut-off line for forming the low-beam light distribution pattern. A light shielding plate may be provided in the space (optical path) from each of the reflection portions 35 to the projection lens 13, or the cut-off line may be formed by optical setting of the incident surface of the lens main body portion 43.

Further, in the first embodiment, the vehicle lamp fitting is mounted on a vehicle in a state in which the heat dissipation member 14 is provided on the reflector member 12. However, the vehicle lamp fitting may be turned upside down when the vehicle lamp fitting is mounted on a vehicle and is not limited to the configuration of the first embodiment. In this case, in the vehicle lamp fitting 10, since the heat dissipation member 14 is positioned on the lower side, the heat dissipation member 14 can be brought into contact with air having a lower temperature, and air having a lower temperature can be introduced through the opening portion 56, and thereby a cooling effect can be obtained. In addition, even if the vehicle lamp fitting 10 is turned upside down when mounted on the vehicle, the positional relationship in the up-down direction can be similar to that of the first embodiment when the vehicle lamp fitting is assembled, and the same effect as that of the first embodiment can be obtained. Further, in the first embodiment, the heat dissipation member 14 is formed to have a plate shape having the front side piece portion 51, the rear side piece portion 52, and the inclined piece portion 53. However, the shape and the number of steps may be appropriately set as long as the heat dissipation member is provided with the light source (light source portion 11) and fixes the projection lens 13 by sandwiching the projection lens 13 between the heat dissipation member and the reflector member 12, and the heat dissipation member is not limited to the configuration of the first embodiment.

In the first embodiment, the screw receiving portion (front side screw receiving portion 38) is provided on the rear side of each lens support portion 37 in the front-rear direction. However, the screw receiving portion (front side screw receiving portion 38) only need to be provided adjacent to each lens support portion 37, and is not limited to the configuration of the first embodiment.

### DESCRIPTION OF REFERENCE NUMERALS

10 . . . vehicle lamp fitting
11 . . . light source portion (as one example of light source)
12 . . . reflector member
13 . . . projection lens
14 . . . heat dissipation member
35 . . . reflection portion
37 . . . lens support portion
37c . . . positioning hole
38 . . . front side screw receiving portion (as one example of screw receiving portion)
41 . . . mounting screw
43 . . . lens main body portion
44 . . . mounting piece portion
47 . . . positioning protrusion
56 . . . opening portion

1. A vehicle lamp fitting comprising:
a light source;
a reflector member having a reflection portion that reflects light emitted by the light source;
a projection lens that projects light reflected by the reflection portion to a front; and
a heat dissipation member provided with the light source and dissipating heat from the light source;
wherein the projection lens is fixed between the heat dissipation member and the reflector member by being sandwiched between the heat dissipation member and the reflector member.

2. The vehicle lamp fitting according to claim 1, wherein the heat dissipation member and the reflector member surround a space in which light travels from the reflection portion to the projection lens.

3. The vehicle lamp fitting according to claim 1, wherein the heat dissipation member is formed to have a plate shape extending from the light source to the projection lens, and
the projection lens is pressed against the reflector member by elastic force of the heat dissipation member.

4. The vehicle lamp fitting according to claim 3, wherein the heat dissipation member is provided with an opening portion between the light source and the projection lens.

5. The vehicle lamp fitting according to claim 3, wherein the projection lens has a lens main body portion that projects light, and a mounting piece portion that protrudes from the lens main body portion, and
the heat dissipation member and the reflector member sandwich the mounting piece portion to fix the projection lens.

6. The vehicle lamp fitting according to claim 5, wherein the reflector member has a lens support portion that supports the mounting piece portion and a screw receiving portion to which the heat dissipation member is mounted via a mounting screw, and the lens support portion and the screw receiving portion are adjacent to each other.

7. The vehicle lamp fitting according to claim 6, wherein the mounting piece portion is provided with a positioning protrusion protruding toward the lens support portion, and
the lens support portion is provided with a positioning hole into which the positioning protrusion can be fitted.
